(19) United States
(12) Patent Application Publication
(10) Pub. No.: US 2006/0092463 A1
(43) Pub. Date: May 4, 2006

(54) Printout system and method using an RIP server

(76) Inventor: Sang-kil Ahn, Suwon-si (KR)

Correspondence Address: STANZIONE & KIM, LLP, 919 18TH STREET, N.W., SUITE 440, WASHINGTON, DC, 20006, US

(21) Appl. No.: 11/262,832

(22) Filed: Nov. 1, 2005

(30) Foreign Application Priority Data
Nov. 2, 2004 (KR) 2004-88239

(51) Int. Cl. G06F 3/12

(52) U.S. Cl. 358/1.15; 358/1.13

(57) ABSTRACT

A printout system and a method using an RIP server to process color images includes an image-forming device connected to a network to print data generated from at least one information-processing device, and the RIP server to receive an image-processing request message including information on the image-forming device through the network from at least one information-processing device, to process images included in the printout data based on a color profile corresponding to the image-forming device, and to send the processed printout data to the image-forming device. Therefore, the colors of the processed images are reproduced closer to the original colors, so the printout quality is improved.

### CROSS-REFERENCE TO RELATED APPLICATIONS

This application claims benefit under 35 U.S.C. § 119 from Korean Patent Application No. 2004-88239, filed on Nov. 2, 2004, the entire contents of which are incorporated herein by reference.

### BACKGROUND OF THE INVENTION

1. Field of the Invention

The present general inventive concept relates to a printout system and a method using a Raster Image Processor (RIP) server, and more particularly, to a printout system and a method of receiving color profiles from a printer and processing images, using an RIP server.

2. Description of the Related Art

Image-forming devices, such as printers and multi-function devices, receive and send data from and to information-processing devices, such as computers, through serial or parallel lines, receive data for creating a printout (hereinafter, referred to as ‘printout data’) from the information-processing devices, and print the printout data on sheets of paper.

Users form the printout data by using application programs loaded in their computers in order to print data including images, and deliver to image-forming devices printout jobs including the printout data formed by using a language such as Printer Control Language (PCL) or PostScript. The image-forming devices carry out various printout jobs, such as image processing, for the delivered printout data, and print the printout data on sheets of paper.

If the printout data transmitted contains an image to be reproduced in color, the image-forming devices generally carry out a certain conversion process for colors of the image depending on color characteristics.

That is, image colors of the printout data generated by a computer are reproduced based on a color space defined suitable for a display unit connected to the computer, but the image colors contained in the transmitted printout data have nothing to do with a print environment, such as print ink or paper, used in the image-forming devices. Therefore, the image contained in the printout data look considerably unnatural in terms of reproduced colors, when printed on paper using the image colors contained in the printout data.

Thus, the image-forming devices convert the color space defined suitable for the display unit into a color space defined depending on the print environment. That is, the image forming devices convert the colors defined suitable for the display unit contained in the transmitted printout data into colors suitable for printout on paper.

Conversion functions, such as mapping tables, used for converting the color space defined depending on display units into the color space defined depending on the image-forming devices as described above are referred to as color profiles for the image-forming devices. The color profiles are different according to types of image-forming devices, so each image-forming device converts the colors of images contained in the printout data into the colors for printout by using a color profile corresponding to the image-forming device, and prints on paper the printout data processed for image enhancement through various image-processing procedures.

Recent changes to business environments require a plurality of computers and peripherals to be connected together into a network so that a plurality of users share a limited number of image-forming devices to perform printout jobs. The image-forming devices can not meet printout job demands of the plurality of users due to their limited data-processing capabilities.

Thus, printer servers have emerged to provide sharing services through the network and to manage printout jobs sent from individual computers sharing an image-forming device connected to the network. The Raster Image Processor (RIP) server is one kind of printer server performing as described above. The RIP is focused on the image-processing functions for printout, performs various image-processing procedures necessary for printout data sent from the computers, and sends the processed printout data to the image-forming devices.

The RIP server performs data-processing procedures that existing image-forming devices can carry out, that is, converts the colors of images contained in the printout data into the colors for printout, performs various image-processing procedures for an image enhancement, and sends the processed printout data including images to the image-forming devices, so as to make up for insufficient data-processing capabilities of the image-forming devices.

The RIP server processes the printout data to be printed out by an image-forming device connected to the network, when it is necessary to convert image colors into printout colors according to a color profile of each image-forming device if the printout data includes color images. The colors conversion is carried out according to the unique color profile of the image-forming device.

However, if the RIP server does not store a color profile for a specific image-forming device due to various reasons such as changes to image-forming devices connected to a network, the RIP server can not carry out color conversion jobs using the color profile for the corresponding image-forming device, which causes a problem by substantially deteriorating a print quality of the corresponding image-forming device.

### SUMMARY OF THE INVENTION

The present general inventive concept provides a printout system including an RIP server to carry out an image-processing process necessary for printing out images by using color profiles of image-forming devices and a method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a printout system using a Raster Image Processor (RIP) server, the printout system comprising an image-forming device connected to a network to print printout data generated by at least one information-processing device, and an RIP server to receive an image-processing request message including data and device information on the image-forming device from the at least one information-processing device through the network, to process images included in the data based on a color profile corresponding to the image-forming device, and to send the processed data to the corresponding image-forming device as the printout data.

The RIP server may include a storage unit to store a plurality of color profiles, and the RIP server may search in the plurality of color profiles of the storage unit for the color profile corresponding to the image-forming device according to the device information on the image-forming device contained in the image-processing request message.

If the color profile is not found in the plurality of color profiles of the storage unit, the RIP server may send to the image-forming device a profile transmission request message requesting a transmission of the color profile.

The image-forming device may send the color profile corresponding to the image-forming device to the RIP server, upon receiving the profile transmission request message.

The RIP server may convert a color space for the printout data into a color space of printing the data with the image-forming device according to the color profile corresponding to the image-forming device.

The foregoing and/or other aspects of the present general inventive concept may also be achieved by providing a printout method using an RIP server connected to a network, to manage printout jobs sent from at least one information-processing device and to process printout data, the printout method comprising receiving an image-processing request message including data and device information on an image-forming device to print printout data, searching in a plurality of stored color profiles for a color profile corresponding to the image-forming device according to the image-forming device, receiving data from the information-processing device and processing images based on the color profile corresponding to the image-forming device, and sending the image-processed printout data to the image-forming device as the printout data.

The printout method may further comprise sending to the image-forming device a profile transmission request message requesting the color profile if the color profile corresponding to the image-forming device is not found in the plurality of stored color profiles.

The printout method may further comprise transmitting the color profile corresponding to the image-forming device by the image-forming device when the request message is received.

The printout method may further include image-processing to convert a color space for the data into a color space for printout of the image-forming device according to the color profile.

The foregoing and/or other aspects of the present general inventive concept may also be achieved by providing a printing system comprising a server unit to receive one or more print jobs each including data of an image to be printed and device information on a printer through which the image is printed, to store a plurality of color profiles, to select one of the plurality of color profiles corresponding to the device information, and to connect a color profile of the data of the image into printout data according to the selected one of the plurality of color profiles so that printout data is printed in the printer.

The foregoing and/or other aspects of the present general inventive concept may also be achieved by providing a method for printing comprising receiving one or more print jobs each including data of an image to be printed and device information on a printer through which the image is printed, storing a plurality of color profiles, selecting one of the plurality of color profiles corresponding to the device information, connecting a color profile of the data of the image into printout data according to the selected one of the plurality of color profiles, and printing the printout data in the printer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a printout system using an RIP server according to an embodiment of the present general inventive concept;

FIG. 2 is a block diagram illustrating the RIP server of the printout system of FIG. 1;

FIG. 3 is a block diagram illustrating a printer of the printout system of FIG. 1; and

FIG. 4 is a flow chart illustrating operations of the RIP server of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

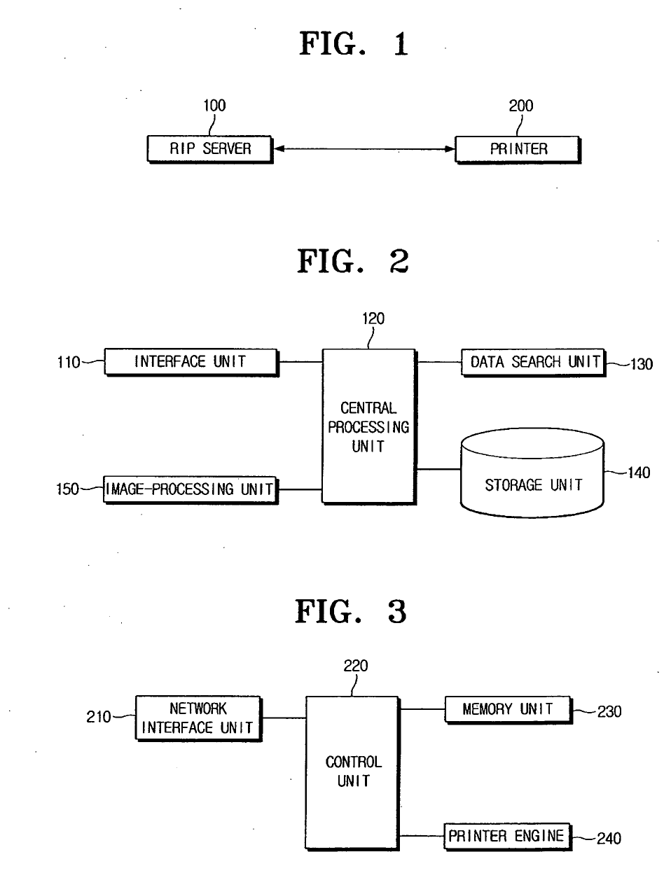

FIG. 1 is a view illustrating a printout system using an RIP server 100 according to an embodiment of the present general inventive concept. The present embodiment will be described referring to a printer 200 as an image-forming device for convenience of explanations, but the image-forming device is not limited to the printer 200.

In the printout system of FIG. 1, the RIP server 100 is connected to the printer 200 through a network and manages printout jobs sent from one or more computers (not shown) connected to the network, processes one or more images according to data contained in the printout jobs, and sends the processed images to the printer 200 to generate printout data.

Only one printer 200 is shown in FIG. 1 for convenience, but the present general inventive concept is not limited thereto. The RIP server 100 may be connected to one or more printers, manages printout jobs of individual printers connected thereto, processes the printout data, and sends the processed printout data to a corresponding printer to generate the printout data.

FIG. 2 is a block diagram illustrating the RIP server of FIG. 1.

In FIG. 2, the RIP server 100 includes an interface unit 110, a central processing unit 120, a data search unit 130, a storage unit 140, and an image-processing unit 150.

The interface unit 110 connects the central processing unit 120 to the plurality of computers (not shown) and the printer 200 through a network, so as for the RIP server 100 to receive the data sent from individual computers or to send the printout data to the printer 200 connected to the network.

The central processing unit 120 controls overall operations of the RIP server 100. For example, if the central processing unit 120 receives an image-processing request message containing first information on the images to be processed and second information on the printer 200 from a computer (not shown) connected to the network, the central processing unit 120 interprets the image-processing request message, and carries out procedures for processing the images based on the first and second information contained therein. The first information on images includes an image data format, an image size, color information, etc., and the second information on the printer 200 contains printer IP information (a network address), a brand name, a model number, etc.

Further, the central processing unit 120 controls the data search unit 130 based on the second information on the printer 200 contained in the image-processing request message, and searches among color profiles stored in the storage unit 140 for a color profile corresponding to the printer 200.

The storage unit 140 stores the color profiles corresponding to different types of printers. Here the storage unit 140 stores the color profiles in a way to easily link the printer IP information, the brand name, or the model number to the corresponding color profile from the stored color profiles, respectively, so that the corresponding color profile can be searched using the second printer information.

The storage unit 140 stores a mapping table, or equivalent information structures, having a list containing storage location addresses, the second information on the printers and the color profiles corresponding thereto. The mapping table or the equivalent information structures are organized to allow easy searches independent from the stored color profiles, so that convenient and rapid searches can be achieved.

If the data search unit 130 searches for a color profile corresponding to the printer 200, the data search unit 130 provides the searched color profile to the image-processing unit 150 through the central processing unit 120. On the contrary, if the color profile corresponding to the printer 200 is not found, the data search unit 130 notifies the central processing unit 120 that no color profile corresponding to the printer 200 exists.

If the corresponding color profile is not stored in the storage unit 140, the central processing unit 120 sends a profile transmission request message to the printer 200 requesting to send its color profile through the interface unit 110. The central processing unit 120 stores then in the storage unit 140 the corresponding color profile sent from the printer 200, and sends the color profile to the image-processing unit 150.

The image-processing unit 150 converts the color space for images included in printout jobs into the color space for printing on the printer 200 using the searched color profile or the color profile sent from the printer 200.

Further, the image-processing unit 150 can perform various image-processing procedures such as an image enhancement, halftone image generation, etc., to improve a printout quality, such as printout data format changes, edge emphasis, or smoothing, based on first information on images contained in the image-processing request message sent from a computer and the second information.

FIG. 3 is a block diagram illustrating the printer 200 of FIG. 1.

In FIG. 3, the printer 200 included in the printout system has a network interface unit 210, a control unit 220, a memory unit 230, and a printer engine 240.

The network interface unit 210 connects the control unit 200 to the network. Therefore, the control unit 220 may communicate with devices, such as computers or the like, connected to the network and with the RIP server connected to the network. Through the network interface 210, the control unit 220 receives data sent from the RIP server 100, or sends data to the RIP server 100 and receives the processed printout data from the RIP server 100.

The control unit 220 controls overall operations of the printer 200. For example, if printout data is sent from the RIP server 100 connected to the network, the control unit 220 controls the printer engine 240 to print the received printout data on one or more sheets of paper.

Further, the control unit 220 communicates with the RIP server 100, and, upon receiving a profile transmission request message from the RIP server 100, sends to the RIP server 100 a color profile corresponding to the printer 200, for example, the corresponding color profile, stored in the memory unit 230.

The memory unit 230 includes one or more non-volatile memories to store various control programs for operations of the printer 200 and one or more volatile memories to store data occurring during operations of the printer 200 and detailed information on the printout data. For example, the volatile memories may temporarily store profile request messages and various data such as the printout data received from the RIP server 100 through the network interface unit 210. Further, the non-volatile memories may store a variety of information, including protocol information, necessary for data communications with the RIP server 100.

The printer engine 240 prints the printout data stored in the memory unit 230 according to a printout command input from the control unit 220.

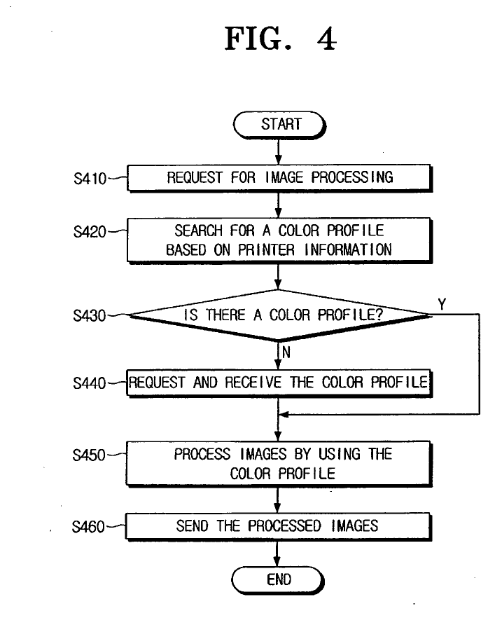

FIG. 4 is a flow chart for illustrating operations of the RIP server of FIG. 1.

First, the RIP server 100 receives an image-processing request message including first information on images to be processed and second information on a printer, from a computer connected to the network. The RIP server 100 interprets information included in the image-processing request message to grasp the first information on the images, including image data formats, image sizes, color information, etc., and the information on the printer, including printer IP information, brand name, model number, etc. in operation S410.

Next, the data search unit 130 of the RIP server 100 searches among color profiles stored in the storage unit 140 for a color profile corresponding to the printer 200 according to the printer information in operation S420.

If the corresponding color profile is not found, the RIP server 100 communicates with the printer 200, that is, the RIP server 100 sends to the printer 200 a profile transmission request message requesting the transmission of the corresponding color profile, and receives the corresponding color profile transmitted by the printer 200 (operation S440).

Next, the RIP server 100 receives the data from the computer which sent the image-processing request message, converts the color space for the images contained in the data into the color space for printout of the printer 200 using the searched color profile or the color profile sent from the printer 200. Then, the RIP server 100 performs various image-processing procedures, such as image enhancement, halftone image generation, etc., for improving a printout quality, such as printout data (processed image) format changes, edge emphasis, smoothing, or the like, and generates the processed printout data to be sent to the printer 200 (operation S450).

Further, the RIP server 100 sends the processed printout data to the printer 200 through the network, and the printer 200 prints the printout data (operation S460).

As stated above, in the present embodiment, if an RIP server receives a color profile from a printer, the RIP server processes images using the received color profile, and sends the processed printout data to the printer for printout, so that the printout quality is enhanced with colors of the processed images reproduced closest to original colors.

Further, even though the color profile corresponding to the printer may not be stored in the RIP server, the existing network connection between the RIP server and the printer may be utilized to send and receive a necessary color profile and to perform image processing accordingly, without user's manual data input, thereby improving an efficiency and convenience of the printout system.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printout system, comprising:
an image-forming device connected to a network to print printout data generated by at least one information-processing device; and
an RIP server to receive an image-processing request message including data and device information on the image-forming device from the at least one information-processing device through the network, to process images included in the data according to a color profile corresponding to the image-forming device, and to send the processed data to the corresponding image-forming device as the printout data.

2. The printout system as claimed in claim 1, wherein:
the RIP server comprises a storage unit to store a plurality of color profiles; and
the RIP server searches in the plurality of color profiles of the storage unit for the color profile corresponding to the image-forming device according to the device information on the image-forming device contained in the image-processing request message.

3. The printout system as claimed in claim 2, wherein, when the color profile corresponding to the image-forming device is not found in the plurality of color profiles of the storage unit, the RIP server sends to the image-forming device a profile transmission request message requesting a transmission of the corresponding color profile.

4. The printout system as claimed in claim 3, wherein the image-forming device sends the color profile corresponding to the image-forming device to the RIP server, upon receiving the profile transmission request message.

5. The printout system as claimed in claim 1, wherein the RIP server converts a color space of the data into a color space for printing the printout data with the image-forming device according to the color profile corresponding to the image-forming device.

6. A printout method using an RIP server connected to a network to manage printout jobs sent from at least one information-processing device and to process printout data, the printout method comprising:
receiving an image-processing request message including data and device information on an image-forming device to print printout data;
searching in a plurality of stored color profiles for a color profile corresponding to the image-forming device according to the device information on the image forming device;
receiving data from the information-processing device and processing images based on the color profile corresponding to the image-forming device; and
sending the image-processed printout data to the image-forming device as the printout data.

7. The printout method as claimed in claim 6, further comprising:
sending to the image-forming device a profile transmission request message requesting the color profile if the color profile corresponding to the image-forming device is not found in the plurality of stored color profiles.

8. The printout method as claimed in claim 7, further comprising:
transmitting the color profile corresponding to the image-forming device by the image-forming device upon receiving the profile transmission request message.

9. The printout method as claimed in claim 6, further comprising:
image-processing to convert a color space for the data into a color space for printout of the image-forming device according to the color profile.

10. A printout system comprising:
a server unit to receive one or more print jobs each including data of an image to be printed and device information on a printer through which the image is printed, to store a plurality of color profiles, to select one of the plurality of color profiles corresponding to the device information, and to connect a color profile of the data of the image into printout data according to the selected one of the plurality of color profiles so that printout data is printed in the printer.

11. The printing system as claimed in claim 10, wherein the server unit is connected to an external computer to receive the data and the device information though a network.

12. The printing system as claimed in claim 10, wherein the server unit is connected to the printer to print the printout data through a network.

13. The printing system as claimed in claim 10, wherein when the color profile corresponding to the printer is not included in the plurality of color profiles, the server unit transmits to the printer a message to request the color profile corresponding to the printer.

14. The printing system as claimed in claim 13, wherein the server unit selects the received color profile as the one of the plurality of color profiles to connect into the printout data.

15. The printing system as claimed in claim 10, wherein the server unit comprises a raster image processor.

16. The printing system as claimed in claim 10, wherein the server unit comprises:
an interface unit to receive the data and information from one or more computers and send the printout data to the printer;
a storage unit to store the plurality of color profiles; and
an image processing unit to search for the one of the plurality of color profiles according to the information on the printer, and to connect the data into the printout data according to the one of the plurality of color profiles.

17. The printing system as claimed in claim 10, wherein the printer comprises:
a network interface to communicate with the server unit;
a memory unit to store a color profile corresponding to the printer; and
a control unit to transmit the color profile to the server unit through the network interface on the one of the plurality of color profile.

18. The printing system as claimed in claim 10, wherein the device information comprises one of a network address, a printer brand name, and a printer model number.

19. The printing system as claimed in claim 18, wherein the server unit selects one of the plurality of color profiles corresponding to the device information based on any of the network address and a combination of the printer brand name and the printer model number.

20. The printing system as claimed in claim 10, wherein the server unit sends the printout data to an external printer having the same as one of the plurality of color profiles of the printer as the printer.

21. The printing system as claimed in claim 10, wherein the server unit selects one of external printers as the printer having same as the one of the plurality of color profiles as the printer.

22. A method for printing comprising:
receiving one or more print jobs each including data of an image to be printed and device information on a printer through which the image is printed;
storing a plurality of color profiles;
selecting one of the plurality of color profiles corresponding to the device information;
connecting a color profile of the data of the image into printout data according to the selected one of the plurality of color profiles; and
printing the printout data in the printer.

23. The method as claimed in claim 22, further comprising: sending to the printer a message to request the color profile corresponding to the printer, when the color profile corresponding to the printer is not included in the plurality of color profiles; and
including a received color profile in the plurality of color profiles corresponding to the device information.
